(19) United States
(12) Patent Application Publication
(10) Pub. No.: US 2018/0134105 A1
(43) Pub. Date: May 17, 2018

(54) HITCH ANTI-RATTLE CLAMP

(71) Applicant: Philip W. Wyers, Centennial, CO (US)

(72) Inventor: Philip W. Wyers, Centennial, CO (US)

(21) Appl. No.: 15/853,837

(22) Filed: Dec. 24, 2017

Related U.S. Application Data
(63) Continuation-in-part of application No. 29/620,151, filed on Jul. 22, 2016.

(51) Int. Cl. B60D 1/48; B60D 1/24; B60D 1/04; B60D 1/06; B60D 1/64; B60D 1/02

(52) U.S. Cl. CPC B60D 1/48; B60D 1/241; B60D 1/02; B60D 1/065; B60D 1/64; B60D 1/04

(57) ABSTRACT

A receiver and draw bar hitch system is enhanced with several embodiments of a reduced play anti-rattle hitch clamp. A typical U shaped bolt can be placed atop the draw bar. A base bar has a forward lip to engage the bottom (or top or side) member of a receiver collar. The base bar has a pair of opposing shoulders to support the legs of the U bolt. Other embodiments comprise a flat plate on the top cross member of the U bolt, a U shaped upper plate to receive the U bolt, or a top shoulder style bar using straight bolts. Another embodiment uses a thick lower bar to replace the shoulders.

### FIELD OF THE INVENTION

The present invention relates to devices that lock a draw bar against the interior of a receiver to dampen vibrations.

### BACKGROUND

The prior art contains several devices that address the problem of damping the vibration or rattling of a draw bar inside a vehicle's receiver during driving and towing a trailer with the draw bar. A brief summary of the prior art follows below.

U.S. Pat. No. 5,879,102 (1999) to Koliopoulos discloses a U shaped clamp with the bolt ends securing a cylindrical, arc-shaped cross-section bar. The arc-shaped side of the bar is positioned within a seat formed by the receiver hitch collar and the draw bar, usually on top of the draw bar. The bolt ends protrude above the bar with nuts pulling the lower U shape cross member tight against the lower collar receiver member, thus locking the draw bar bottom against the bottom of the receiver.

U.S. Pat. No. 6,131,938 (2000) to Speer disclosers a pair of opposing plates that straddle opposing ridges of the receiver collar while simultaneously clasping the sides of the draw bar. Tightening two bolts/nuts that secure the plates together prevents rattling.

Trailer hitch lower plate and U bolt assembles are available. The U bolt rests atop the draw bar. A forward edge of a flat plate catches a lower edge of the receiver collar. The rear of the plate contacts the bottom of the draw bar. Tightening the U bolt nuts clamps the draw bar down into the receiver. However, a counter force up on the draw bar is caused by tightening the nuts. See Amazon.com, “84101 Super Corrosion Trailer Hitch Stabilizer” and FIG. 13.

What is needed in the art is an anti-rattle device that does not exert a counter force on the draw bar and that uses shoulders or an equivalent to stabilize the nut end of the U bolt to essentially eliminate all play in the clamp.

The present inventor provides a pair of opposed (nominally at least 0.5 inch high) shoulders on a nut end cross bar to secure the U bolt ends. The horizontal cross member of the U bolt may have a flat plate to rest over the draw bar further reducing any play between the draw bar and the horizontal cross member of the U bolt. See FIG. 12.

### SUMMARY OF THE INVENTION

The main aspect of the present invention is to provide a U bolt style anti-rattle hitch clamp that has a base bar with shoulders to receive the legs of the U bolt.

Another aspect of the present invention is to provide a top plate on the U bolt to rest on the draw bar.

Another aspect of the present invention is to form the base bar from a single casting.

Another aspect of the present invention is to maintain a thin (nominal 1 ¾″ depth) for the base bar so as to fit under most if not all draw bars with the tow ball attached.

Another aspect of the present invention is to provide an alternate embodiment of a thick base bar without shoulders which functions equivalent to shoulders.

Another aspect of the present invention is to provide an alternate embodiment wherein a top bar accepts the horizontal member of the U bolt.

Another aspect of the present invention is to provide a straight bolt embodiment which clamps opposing U shaped brackets together.

Other aspects of this invention will appear from the following description and appended claims, reference being made to the accompanying drawings forming a part of this specification wherein like reference characters designate corresponding parts in the several views.

In operation a simple U bolt rests atop the draw bar. A base bar has a forward lip that catches the lower (or side or upper) collar of the receiver. The base bar has at least half inch high shoulders that receive the legs of the U bolt. When the nuts are tightened no contact of the base bar is made with the draw bar. Thus, all the clamping forces of the nuts are between the receiver and the draw bar. Remarkably even hand tightened nuts provide a zero play coupling of the draw bar to the receiver. It is recommended to tighten the nuts so that they don't rattle off.

### BRIEF DESCRIPTION OF THE DRAWINGS

FIG. 1 is a front perspective view of a first embodiment of the receiver hitch clamp.

FIG. 2 is a front elevation view of the FIG. 1 embodiment.

FIG. 3 is a top plan view of the FIG. 1 embodiment.

FIG. 4 is a right side elevation view of the FIG. 1 embodiment.

FIG. 5 is a rear elevation view of the FIG. 1 embodiment.

FIG. 6 is a bottom plan view of the FIG. 1 embodiment.

FIG. 7 is a side elevation view of the FIG. 1 embodiment installed.

FIG. 8 is a front elevation view of a second embodiment having a top bracket housing the U bolt.

FIG. 9 is an exploded view of the FIG. 8 embodiment.

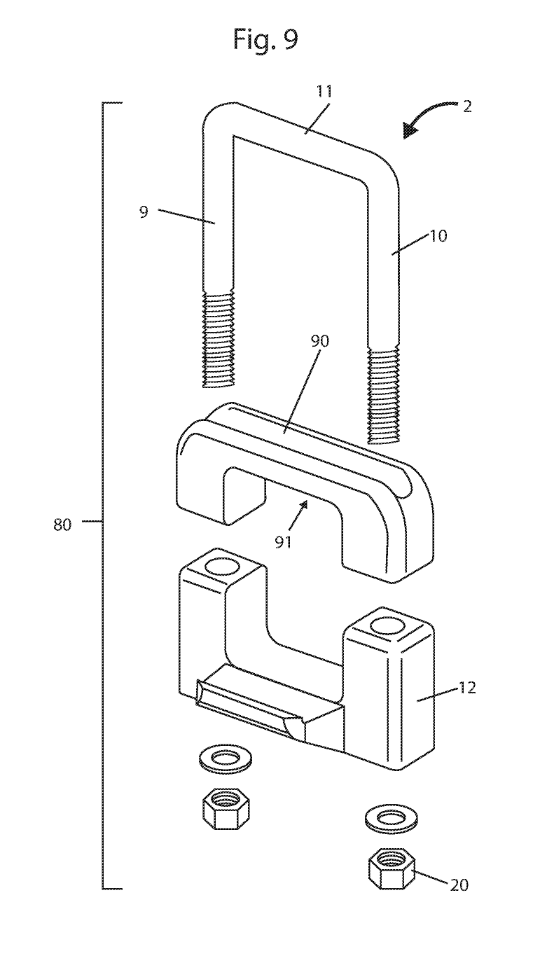

FIG. 10 is a front elevation view of a third embodiment.

FIG. 11 is a front elevation view of a fourth embodiment.

FIG. 12 is a top perspective view of an alternate embodiment U bolt.

FIG. 13 (prior art) is a top perspective view of a plate style device.

Before explaining the disclosed embodiments in detail, it is to be understood that the embodiments are not limited in application to the details of the particular arrangements shown, since other embodiments are possible. Also, the terminology used herein is for the purpose of description and not of limitation.

### DETAILED DESCRIPTION OF THE DRAWINGS

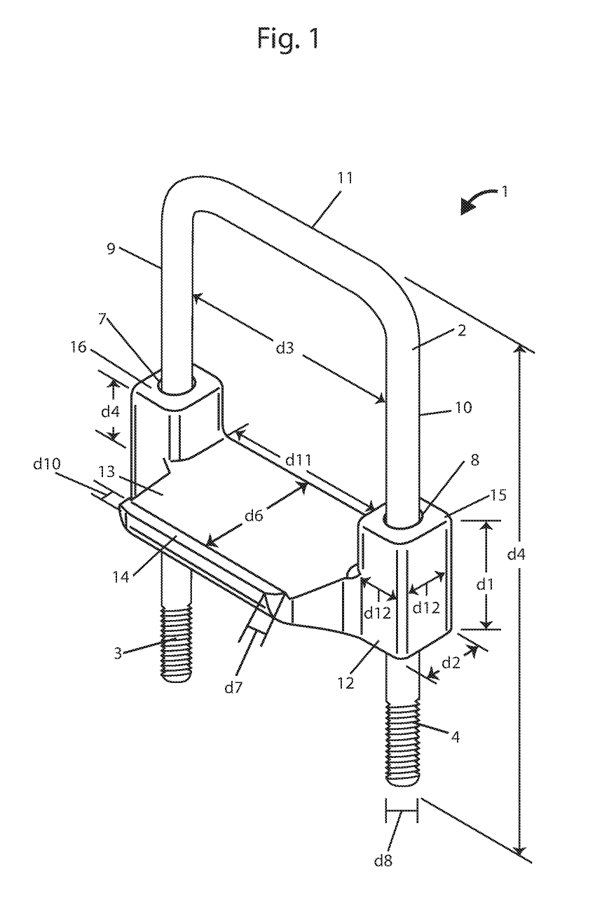

Referring first to FIG. 1 an anti-rattle hitch clamp 1 has a U shaped bolt 2 (nominally stainless steel) with threaded bolt ends 3,4. Legs 9,10 (parallel) pass through holes 7,8 in a snug fashion so as to minimize any rattling. The cross member 11 is sized for standard draw bar widths including 2, 2.5 and 3 inch. Nominal dimensions for a 2.5 inch draw bar embodiment shown in FIG. 1 are d1=1 10/16″, d2= 14/16″, d3=3 1/16″, d4= 15/16″, d5=4 14/16, d6=1 14/16″, d7= 2/16″, d8= 6/16″, d9=2 4/16″, d10= 2/16″, d11=2 9/16″, d12= 14/16″. Each shoulder has at least about 0.82 square inch contact with the draw bar.

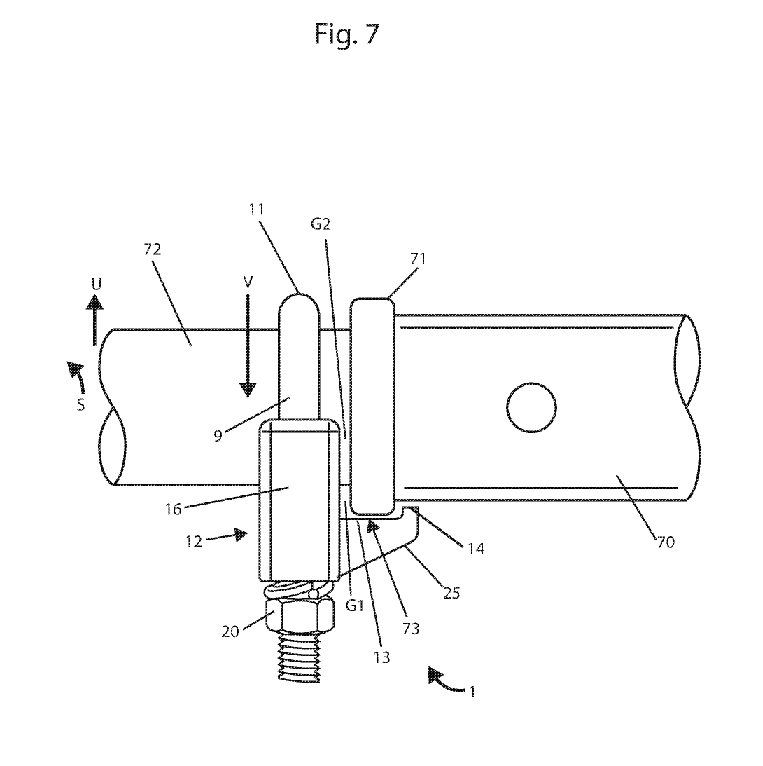

The base bar 12 comprises a one piece casting (nominally aluminum alloy) having a flat horizontal upper face 13 with a forward flange 14. This flange or rim 14 is sized to connect against a receiver collar member as shown in FIG. 7. Shoulders 15,16 are at right angles to the upper face 13. The height d4 of the shoulders 15,16 above the upper face 13 can range from about 3/16 inch to about 1 14/16 inch.

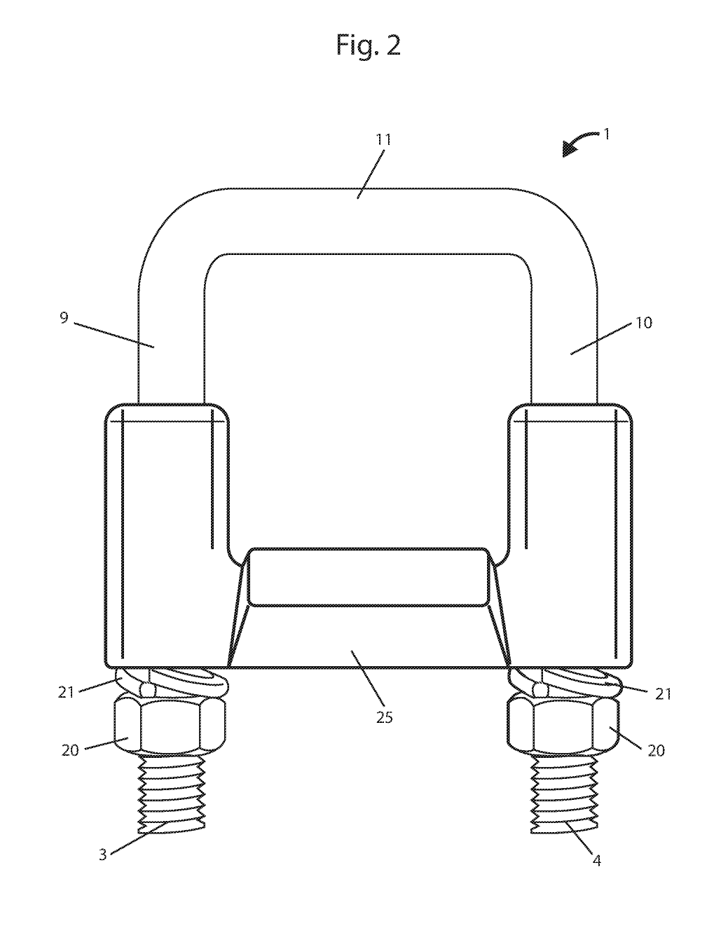

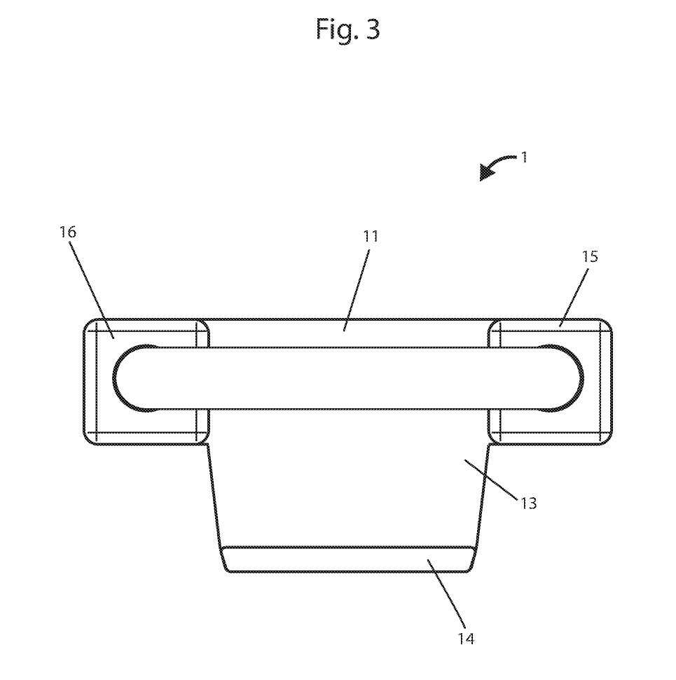

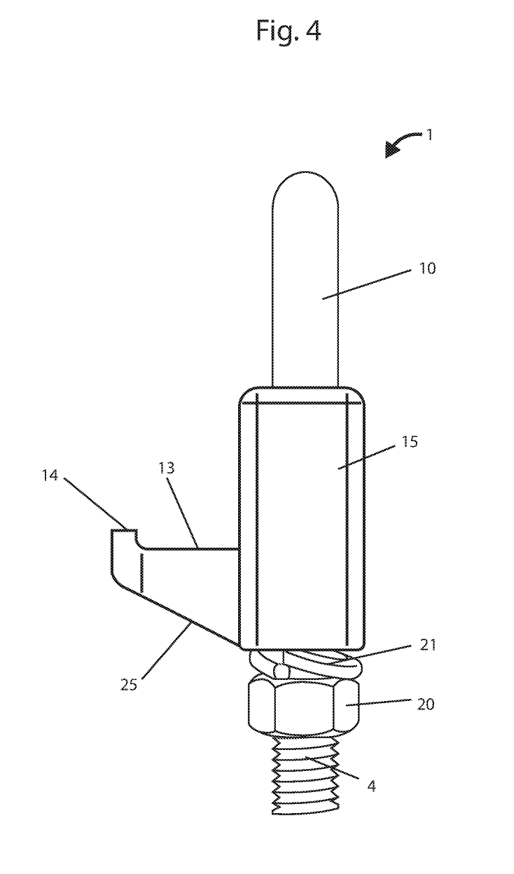

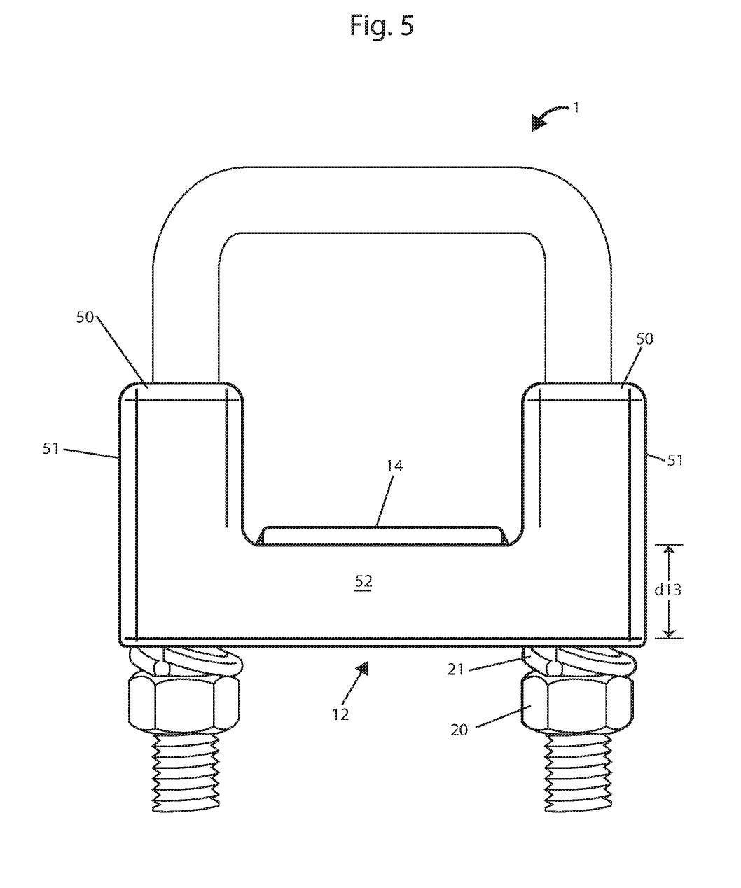

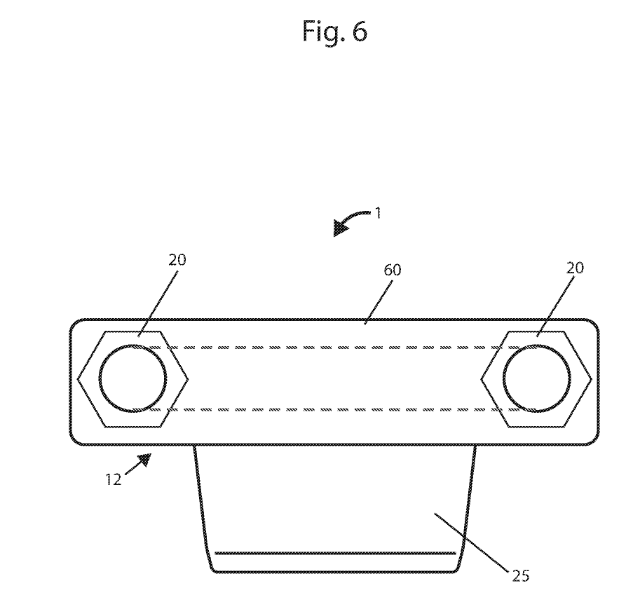

In FIG. 2 the nuts 20 and washers 21 are shown. The leveled nose 25 saves material costs. FIG. 3 shows the cross member 11. FIG. 4 shows leg 10. FIG. 5 shows the back 52 of the base bar 12. FIG. 6 shows the bottom 60 of the base bar 12.

Referring next to FIG. 7 a standard 2 inch receiver 70 has the standard 2 inch draw bar 72 telescopically installed therein in a known manner. Traditional rattling occurs when the draw bar 72 moves up and down shown by arrow U and side to side shown by arrow S. The receiver usually has a four sided collar 71. Range Rovers® only have side collar members, and the present inventions mount sideways to accommodate such receivers. The present inventions can also be mounted upside down.

When the nuts 20 are tightened the critical stress point 73 is formed between the collar member 71 (in this case the lower rim 71L of the collar member), and the upper face 13 of the base bar 12. The cross member 11 is creating a downward force vector V on the top of the draw bar 72. The gap G1 between the bottom of the draw bar 72 and the base bar 12 ensures that no counter force upwards is imparted to the draw bar 72 in this locked position shown with bolts 20 tightened. It is surprising that even with bolts 20 only hand tightened, the rattle between the receiver 70 and draw bar 72 is eliminated. However, the nuts would rattle off if not tightened as shown. The flange 14 must be forward of the collar 71. A gap G2 between the shoulder 16 and the collar 71 is optional.

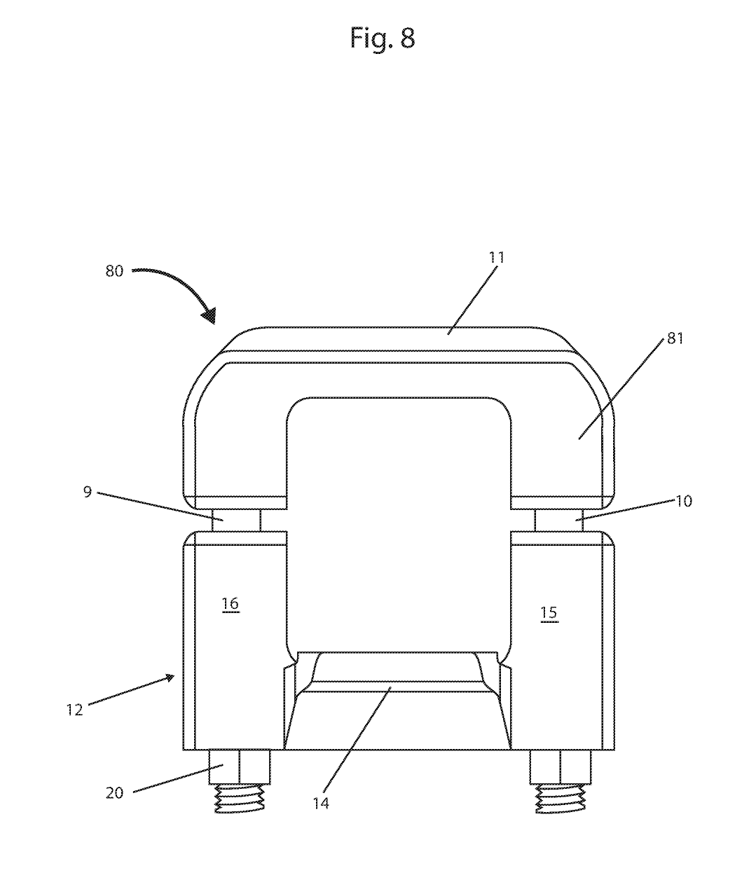

Referring next to FIGS. 8,9 an alternate embodiment anti-rattle hitch clamp 80 is shown to add a top U shaped bar 81 to the same base bar 12 and U shaped bolt 2. A groove 90 houses the cross member 11. The bottom 91 of the top U shaped bar 81 adds to the clamping area applied to the top of the draw bar 72.

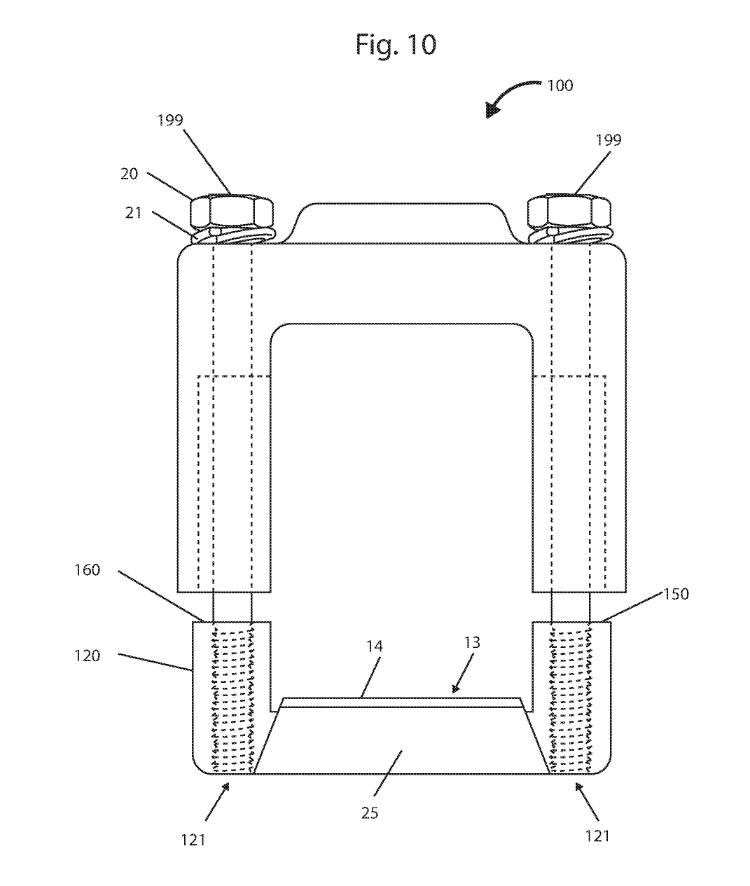

Referring next to FIG. 10 an alternate embodiment anti-rattle hitch clamp 100 is shown to have a base bar 120 with threaded holes 121. Shoulders are labeled 150, 160. Straight bolts 199 could be 2 7/16″ bolts. The bolts 199 draws the top U bracket 189 against the base bar 120. This embodiment could replace base bar 120 with base bar 12 shown in FIG. 1.

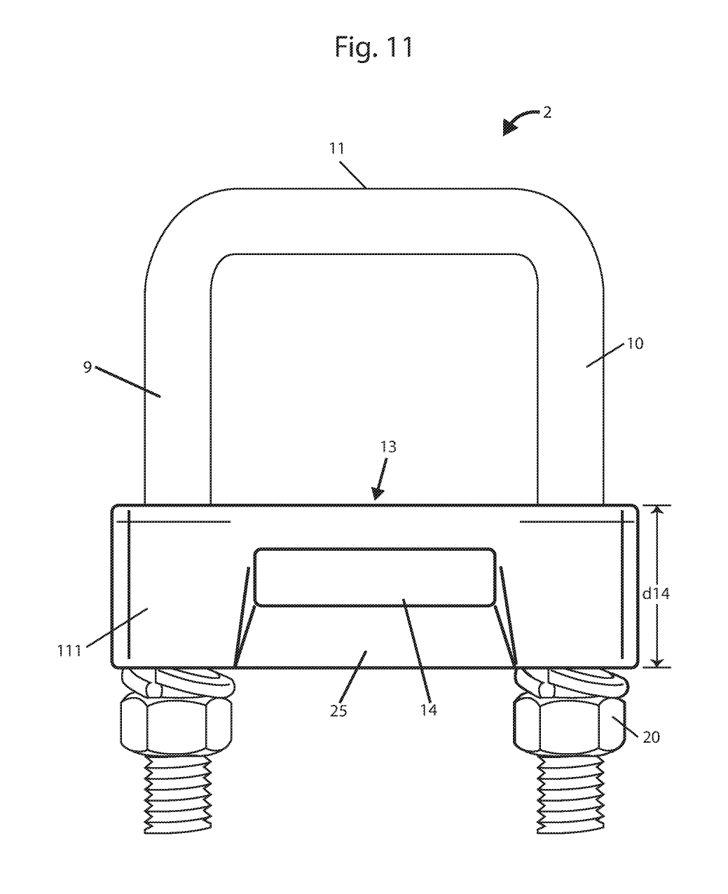

Referring next to FIG. 11 an alternate embodiment anti-rattle hitch clamp 110 replaces any shoulders with a thick base bar 111 that has a thickness d14 of at least about 0.5 inch.

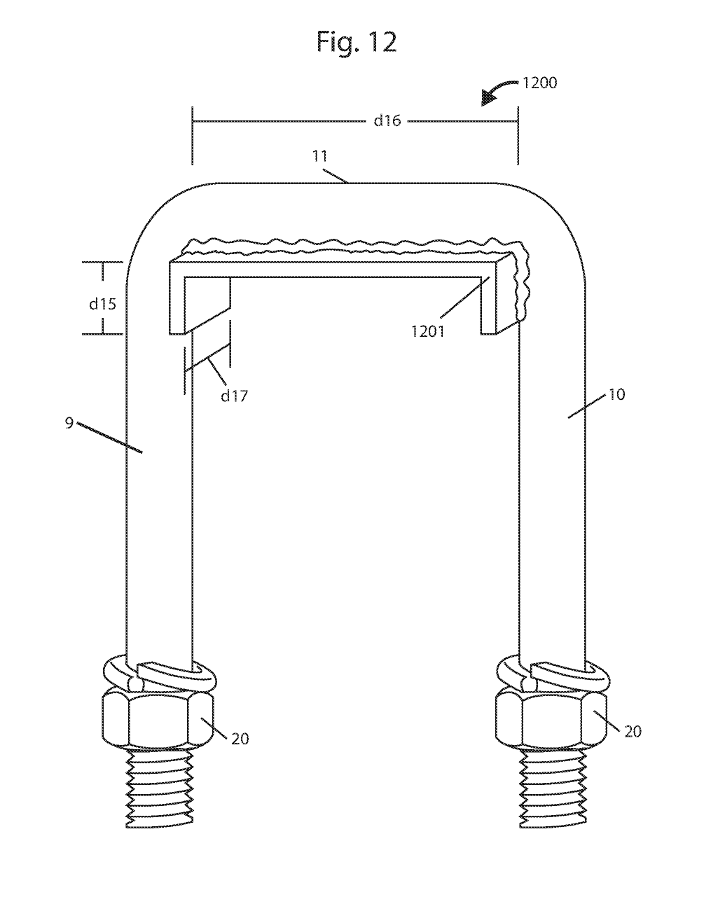

Referring next to FIG. 12 an alternate embodiment U shaped bolt 1200 has a rectangular plate 1201 welded across the cross member 11. This could be used in place of U shaped bolt 2 of FIG. 1. This plate 1201 adds forward and backward leverage against the draw bar from the force of the U bolt. It has a surface contact area on the draw bar of about a minimum of 0.625 square inches. Nominal dimensions are d15=¾″, d16=2 ⅜″, d17=1″.

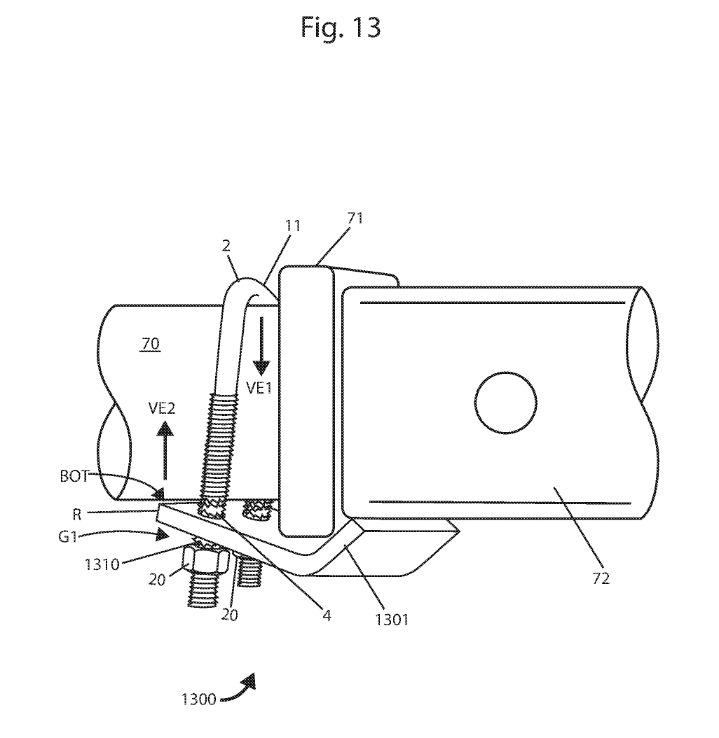

Referring next to FIG. 13 (prior art) an anti-rattle device 1300 uses the same U shaped bolt 2. Nuts 20 draw a plate 1301 upwards as the U shaped bolt 2 is drawn downwards. A rear R of the plate 1301 does contact the bottom of the draw bar at BOT. This causes a counter vector VE2 to work against the downward vector VE1.

Problems with this prior art embodiment include wear on threads 4 as the U shaped bolt 2 wobbles in the plate 1301. The top edge 1310 of the nut 20 wears. A gap G1 occurs between the top of nut 20 and the bottom of plate 1301. The cross member 11 can warp. Each of these issues contributes to rattle.

While a number of exemplifying features and embodiments have been discussed above, those of skill in the art will recognize certain modifications, permutations, additions and subcombinations thereof. No limitation with respect to the specific embodiments disclosed herein is intended or should be inferred.

I claim:

1. An anti-rattle hitch clamp comprising:
a U shaped bolt having threaded bolt ends;
a base bar having opposite shoulders extending above a flat upper surface of the base bar;
said shoulders each having a through hole to receive each bolt end respectfully;
said flat upper surface having a forward upward extending ledge suitable to engage a collar of a receiver; a nut at each bolt end; and
wherein placing a cross member of the U bolt on a side of a draw bar, placing the base bar on an opposite side of the draw bar, mounting the upward extending ledge adjacent a receiver collar, placing the bolt ends through the respective through hole, and tightening the nuts draws the cross member of the U bolt against the draw bar thus securing the draw bar against a side of the receiver and secures the flat upper surface against the receiver collar such that the flat upper surface does not contact the draw bar.

2. The clamp of claim 1, wherein the shoulders each have a height of at least about 0.5 inch.

3. The clamp of claim 1, wherein the base bar has a thickness of at least about 0.5 inch.

4. The clamp of claim 1, wherein the base bar and the shoulders are made from a single coating.

5. The clamp of claim 1, wherein the cross member further comprises a flat channel bracket sized to engage the draw bar.

6. The clamp of claim 1, further comprising an upper U shaped brace sized to mount against the shoulders, said brace having through holes for the bolt ends and a groove for receiving the cross member.

7. An anti-rattle clamp comprising:
a U bolt means functioning to slidingly engage a base plate via shoulders on the base plate that have through holes;
a tighter means at a threaded end of each leg of the U bolt means, said tightener means functioning to force the base plate toward a cross member of the U bolt means;
a forward flange on the base plate sized to catch a receiver collar member on a receiver;
wherein a draw bar in the receiver is wedged against the receiver when the U bolt means rests on the draw bar; and
wherein a singular contact between the base plate and the draw bar occurs at a junction of the forward flange and the receiver collar member.

8. The anti-rattle clamp of claim 7, wherein the U bolt means further comprises a flat bracket across the cross member of the U bolt means.

9. The anti-rattle clamp of claim 7, wherein each shoulder has a height of at least about 0.5 inch above a top surface of the base plate.

10. The anti-rattle clamp of claim 8, wherein each shoulder has a height of at least about 0.5 inch above a top surface of the base plate.

11. The anti-rattle clamp of claim 7, wherein the shoulders are integral with the base plate, do not project above the base plate, and a thickness of the base plate is at least about 0.75 inch.

12. An anti-rattle hitch clamp comprising:
a top upside down U shaped bracket having a central opening sized to fit over a draw bar;
a lower U shaped bracket having a central opening sized to fit under the draw bar and connect to the top upside down U shaped bracket via a pair of straight bolts engaged through holes running through the brackets;
said lower U shaped bracket having a forward flange sized to engage a receiver collar member;
wherein tightening the straight bolts in a receiving nut means at a threaded end of each straight bolt forces the forward flange in a direction opposite from an opposing direction of the top upside down U shaped bracket and the draw bar; and
wherein the draw bar is nested against the receiver in an anti-rattle position without any contact of the lower U shaped bracket to the draw bar except on the receiver collar member.

13. The clamp of claim 12, wherein the nut means further comprises threads in the lower U shaped bracket.

14. The clamp of claim 12, wherein the nut means further comprises a nut separate from the lower U shaped bracket.

15. An improvement to a receiver having a collar with a draw bar telescopically inserted into the receiver, the p improvement comprising:
a U shaped bolt straddling a first side of the draw bar;
said U shaped bolt have a cross member with a flat bracket contacting the draw bar:
a base bar having through holes for each leg of the U shaped bolt;
said base bar straddling an opposing side to the first side of the draw bar;
each leg of said U shaped bolt having a nut tightening a top face flange of the base bar against a collar member of the receiver;
said base bar having opposing shoulders contacting the draw bar; and
a minimum total surface area of the flat bracket plus all area of contact of the two shoulders is at least 2.0 square inches.

16. The improvement of claim 15 further comprising a gap between the top face of the base bar and the draw bar.
